(19) United States
(12) Patent Application Publication
(10) Pub. No.: US 2023/0360843 A1
(43) Pub. Date: Nov. 9, 2023

(54) ELECTRONIC COMPONENT

(71) Applicant: Murata Manufacturing Co., Ltd., Kyoto-fu (JP)

(72) Inventors: Yuuta HOSHINO, Nagaokakyo-shi (JP); Yuuki KITADAI, Nagaokakyo-shi (JP)

(73) Assignee: Murata Manufacturing Co., Ltd., Kyoto-fu (JP)

(21) Appl. No.: 18/355,821

(22) Filed: Jul. 20, 2023

Related U.S. Application Data
(63) Continuation of application No. PCT/JP2021/044963, filed on Dec. 7, 2021.

(30) Foreign Application Priority Data
Feb. 1, 2021 (JP) 2021-014488

(51) Int. Cl. H01F 27/29

(52) U.S. Cl. CPC H01F 27/292

(57) ABSTRACT

An electronic component includes a ceramic base containing a Cu element, an outer electrode partially covering a surface of the base, and a Cu segregate containing a Cu element. The outer electrode has an underlying electrode layer on the base, the underlying electrode layer has a conductor portion containing a conductor and a glass portion containing glass, and the Cu segregate is in contact with the base and the glass portion at an interface between the base and the glass portion.

### CROSS-REFERENCE TO RELATED APPLICATIONS

This application claims benefit of priority to International Patent Application No. PCT/JP2021/044963, filed Dec. 7, 2021, and to Japanese Patent Application No. 2021-014488, filed Feb. 1, 2021, the entire contents of each are incorporated herein by reference.

### BACKGROUND

### Technical Field

The present disclosure relates to an electronic component.

### Background Art

A known multilayer coil component includes an outer electrode containing glass formed on the surface of a base made of a ferrite sintered body.

Japanese Unexamined Patent Application Publication No. 2017-204565 discloses a multilayer coil component including a base made of a ferrite sintered body, a coil constituted by electrically coupling a plurality of inner conductors juxtaposed in the base, and an outer electrode disposed on an end face side of the base, wherein a surface of the base is covered with an insulating layer containing glass.

### SUMMARY

However, the multilayer coil component described in Japanese Unexamined Patent Application Publication No. 2017-204565 has poor adhesion between the base and the outer electrode and has room for improvement in the adhesion.

The present disclosure provides an electronic component with high adhesion between a base and an outer electrode.

One embodiment of an electronic component according to the present disclosure includes a ceramic base containing a Cu element, an outer electrode partially covering a surface of the base, and a Cu segregate containing a Cu element. The outer electrode has an underlying electrode layer on the base, the underlying electrode layer has a conductor portion containing a conductor and a glass portion containing glass, and the Cu segregate is in contact with the base and the glass portion at an interface between the base and the glass portion.

The present disclosure can provide an electronic component with high adhesion between a base and an outer electrode.

### BRIEF DESCRIPTION OF THE DRAWINGS

FIG. 1 is a schematic perspective view of one example of an electronic component according to an embodiment of the present disclosure;

FIG. 2 is a cross-sectional view taken along the line II-II of FIG. 1;

FIG. 3 is a schematic perspective view of another example of an electronic component according to an embodiment of the present disclosure;

FIG. 4 is a cross-sectional view taken along the line IV-IV of FIG. 3;

FIG. 5 is a schematic cross-sectional view of one example of the state of an interface between a base and a glass portion in one embodiment of an electronic component according to the present disclosure;

FIG. 6 is a schematic cross-sectional view of another example of the state of an interface between a base and a glass portion in one embodiment of an electronic component according to the present disclosure;

FIG. 7 is a schematic cross-sectional view of still another example of the state of an interface between a base and a glass portion in one embodiment of an electronic component according to the present disclosure;

FIG. 8 is an elemental mapping image of Cu at an interface between a base and a glass portion of an electronic component according to Example 2;

FIG. 9 is an elemental mapping image of Si in the same field of view as in FIG. 8;

FIG. 10 is a superimposed image of FIG. 8 and FIG. 9;

FIG. 11 is an elemental mapping image of Cu at the interface between the base and the glass portion of the electronic component according to Example 2; and

FIG. 12 is an elemental mapping image of Si in the same field of view as in FIG. 11.

### DETAILED DESCRIPTION

An electronic component according to the present disclosure is described below. However, the present disclosure is not limited to the following embodiments, and various modifications may be made in them without departing from the gist of the present disclosure.

It goes without saying that the following embodiments are illustrative, and structures described in different embodiments can be partially replaced or combined. In the second embodiment and subsequent embodiments, matters common to the first embodiment are not described, and only different points are described. In particular, the same operational advantages of the same structure are not described in each embodiment.

Drawings shown below are schematic and may have the dimensions, the scale of the aspect ratio, and the like different from those of actual products.

One embodiment of an electronic component according to the present disclosure includes a ceramic base containing a Cu element, an outer electrode partially covering a surface of the base, and a Cu segregate containing a Cu element, wherein the outer electrode has an underlying electrode layer on the base, the underlying electrode layer has a conductor portion containing a conductor and a glass portion containing glass, and the Cu segregate is in contact with the base and the glass portion at an interface between the base and the glass portion.

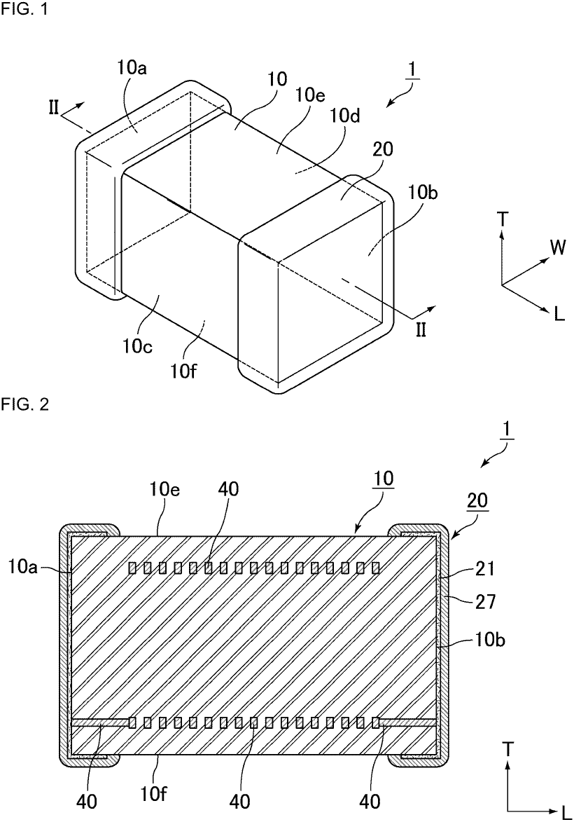

FIG. 1 is a schematic perspective view of one example of an electronic component according to an embodiment of the present disclosure.

An electronic component 1 illustrated in FIG. 1 includes a base 10 and an outer electrode 20 partially covering the surface of the base 10.

The base 10 has an approximately rectangular parallelepiped shape with a first end face 10a and a second end face 10b that face each other in the length direction L, with a first side surface 10c and a second side surface 10d that face each other in the width direction W perpendicular to the length direction L, and with an upper surface 10e and a bottom surface 10f that face each other in the thickness direction T perpendicular to the length direction L and to the width direction W.

The outer electrode 20 is provided so as to cover the first end face 10a and the second end face 10b. The outer electrode 20 covering the first end face 10a is partially formed so as to partially surround the first side surface 10c, the second side surface 10d, the upper surface 10e, and the bottom surface 10f of the base 10. The outer electrode 20 covering the second end face 10b is partially formed so as to partially surround the first side surface 10c, the second side surface 10d, the upper surface 10e, and the bottom surface 10f of the base 10.

FIG. 2 is a cross-sectional view taken along the line II-II of FIG. 1.

As illustrated in FIG. 2, the base 10 has a conductor layer 40 inside. The conductor layer 40 is exposed at the first end face 10a and the second end face 10b of the base 10 and is electrically coupled to the outer electrode 20. The conductor layer 40 forms a coil as a whole. The coil axis of a coil formed by the conductor layer 40 is parallel to the length direction L.

The outer electrode 20 has an underlying electrode layer 21 disposed on the base 10 and a covering layer 27 disposed on the surface of the underlying electrode layer 21.

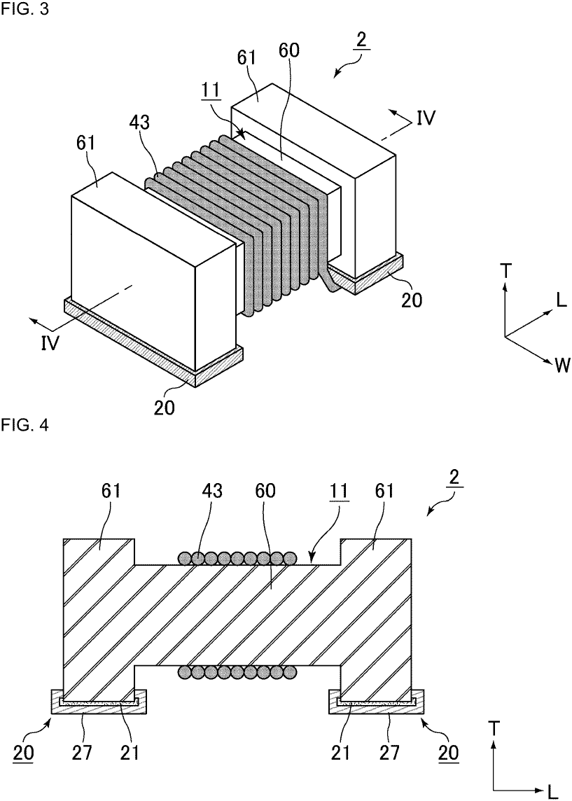

FIG. 3 is a schematic perspective view of another example of an electronic component according to an embodiment of the present disclosure.

An electronic component 2 illustrated in FIG. 3 includes a base 11 and an outer electrode 20 partially covering the surface of the base 11. The base 11 has a barbell shape with a columnar wound core portion 60 wound with a winding wire 43, and with a flange 61 coupled to both end portions of the wound core portion 60 in the length direction L. The winding wire 43 is wound around the wound core portion 60 of the base 11. Although not shown in the figure, an end portion of the winding wire 43 is coupled to the outer electrode 20.

FIG. 4 is a cross-sectional view taken along the line IV-IV of FIG. 3.

As illustrated in FIG. 4, the base 11 has no conductor layer inside.

The outer electrode 20 has the underlying electrode layer 21 disposed on the base 11 and the covering layer 27 disposed on the surface of the underlying electrode layer 21.

### Base

In one embodiment of an electronic component according to the present disclosure, the base is a ceramic containing a Cu element.

Examples of the ceramic containing a Cu element include known ceramics, such as ferrite, alumina, barium titanate, and Zn ceramics, containing a Cu element.

The ceramic containing a Cu element may contain an additive agent, such as Mn₃O₄, Co₃O₄, SnO₂, Bi₂O₃, or SiO₂.

The base preferably has a Cu element content of 6% by mole or more and 10% by mole or less (i.e., from 6% by mole to 10% by mole).

The Cu element content of the base does not include the Cu element constituting the Cu segregate on the surface of the base.

The Cu element content of the base can be measured as a value from which the influence of segregation is eliminated by polishing the base to expose a cross section of 10 µm or more inside from the surface of the base and performing wavelength-dispersive X-ray fluorescence (WD-XRF) measurement with a spot diameter of φ1 µm or more. The WD-XRF measurement may be performed on approximately five samples to further reduce the variation depending on the measurement point.

The Fe element content of the base is preferably 40% by mole or more and 49.5% by mole or less (i.e., from 40% by mole to 49.5% by mole) in terms of Fe₂O₃.

The Ni/Zn mole ratio of the base is preferably, but not limited to, 1.8 or more and 2.8 or less (i.e., from 1.8 to 2.8).

The shape of the base is, for example, but not limited to, a cubic shape, a rectangular parallelepiped shape, a barbell shape, an H shape, an I shape, or an annular shape.

Although the base may have any external dimensions, a smaller base has a smaller contact area between the base and the outer electrode and significantly makes it difficult to improve the adhesion between the base and the outer electrode.

For example, the external dimensions of the base are preferably 5.7 mm or less in length × 5.0 mm or less in width × 5.0 mm or less in height, particularly preferably 1.6 mm or less in length × 0.8 mm or less in width × 0.8 mm or less in height.

The base may have a conductor layer inside.

A conductor layer formed inside the base may form a passive element, such as a coil, a capacitor, a resistor, or a thermistor. A plurality of passive elements may be formed inside the base.

A passive element formed inside the base may have any orientation. Thus, the coil axis of a coil formed inside the base may be horizontal or vertical to the component side of an electronic component. Furthermore, the number of coils formed inside the base may be one or two or more.

An electronic component according to the present disclosure including a coil formed in the base is, for example, a multilayer coil component and, depending on the type of passive element constituted by a conductor layer, may be a multilayer capacitor component, a multilayer resistance component, a multilayer thermistor component, or the like.

The base may have no conductor layer inside.

In such a case, the base can be wound with a winding wire and can also be used as a wound core.

An electronic component according to the present disclosure including the base wound with a winding wire is, for example, a wound coil component. The number of coils formed by winding a winding wire around the base may be one or two or more.

### Outer Electrode

In one embodiment of an electronic component according to the present disclosure, the outer electrode partially covers the surface of the base.

The outer electrode has an underlying electrode layer on the base.

The underlying electrode layer has a conductor portion containing a conductor and a glass portion containing glass.

In the underlying electrode layer, the conductor portion plays a role of ensuring electrical conductivity, and the glass portion plays a role of improving adhesiveness to the base.

The conductor portion preferably contains, as a conductor, at least one metal element selected from the group consisting of a Ni element, a Sn element, a Pd element, a Au element, a Ag element, a Pt element, a Bi element, a Zn element, and a Cu element. Furthermore, it is preferable to contain electrically conductive particles containing these metal elements.

The conductor portion preferably contains a Ag element as a conductor. The Ag element has high electrical conductivity. An underlying electrode layer that contains a conductor containing a Ag element as a conductor can be easily formed.

The average particle size of the electrically conductive particles is preferably, but not limited to, 1.0 µm or more and 15 µm or less (i.e., from 1.0 µm to 15 µm).

The weight ratio of the conductor portion in the underlying electrode layer is preferably, but not limited to, 71% by weight or more and 98% by weight or less (i.e., from 71% by weight to 98% by weight).

Examples of the glass include B-Si glass, Ba-B-Si glass, B-Si-Zn glass, B-Si-Zn-Ba glass, and B-Si-Zn-Ba-Ca-Al glass. In addition to these, alkali metal glasses, such as Na-Si glass, K-Si glass, and Li-Si glass; alkaline-earth metal glasses, such as Mg-Si glass, Ca-Si glass, Ba-Si glass, and Sr-Si glass; and Ti-Si glass, Zr-Si glass, and Al-Si glass can also be used.

The glass may be crystalline glass.

The weight ratio of the glass in the underlying electrode layer is preferably, but not limited to, 2% by weight or more and 15% by weight or less (i.e., from 2% by weight to 15% by weight).

When the weight ratio of the glass in the underlying electrode layer is 15% by weight or less, the underlying electrode layer does not have too high a resistance value. When the weight ratio of the glass in the underlying electrode layer is 2% by weight or more, the underlying electrode layer can have an increased density, and a plating solution and moisture are prevented from entering the underlying electrode layer or entering the base through the underlying electrode layer.

A covering layer may be further provided on the surface of the underlying electrode layer.

The covering layer is preferably, for example, a plating layer provided on the surface of the underlying electrode layer.

The plating layer preferably contains at least one metal selected from the group consisting of Cu, Ni, Sn, Pd, Au, Ag, Pt, Bi, and Zn. The plating layer may be a single layer or two or more layers. The plating layer is more preferably a layer including a nickel plating layer and a tin plating layer provided on the underlying electrode layer. The nickel plating layer prevents water from entering the base, and the tin plating layer improves the mountability of the electronic component.

The outer electrode preferably has a thickness of 10 µm or more and 20 µm or less (i.e., from 10 µm to 20 µm).

In the outer electrode composed only of the underlying electrode layer, the thickness of the underlying electrode layer corresponds to the thickness of the outer electrode.

On the other hand, in the outer electrode further including a covering layer formed on the surface of the underlying electrode layer, the thickness of the outer electrode is the total of the thickness of the underlying electrode layer and the thickness of the covering layer.

The thickness of the underlying electrode layer, the thickness of the covering layer, and the thickness of the outer electrode can be measured by observing a cross section of the outer electrode in the thickness direction with a scanning electron microscope (SEM).

### Cu Segregate

In one embodiment of an electronic component according to the present disclosure, the Cu segregate containing the Cu element is in contact with the base and the glass portion at the interface between the base and the glass portion.

The Cu segregate at the interface between the base and the glass portion enhances the adhesion between the base and the glass portion.

The Cu segregate may be present anywhere on the base and is preferably present at the grain boundary of the ceramic of the base. The grain boundary of the ceramic of the base has a concave shape on the surface of the base. Thus, the Cu segregate at the grain boundary with the concave shape causes an anchoring effect, which further improves the adhesion between the Cu segregate and the base.

The Cu segregate may have any composition that contains at least the Cu element, and is, for example, Cu, CuO, or Cu₂O. The Cu segregate may contain glass.

A plurality of Cu segregates may be present at the interface between the base and the glass portion. A plurality of Cu segregates at the interface between the base and the glass portion can further enhance the adhesion between the base and the glass portion.

The presence of Cu segregates at the interface between the base and the glass portion can be confirmed by observing the interface between the base and the glass portion in a section of the electronic component by scanning electron microscope-energy dispersive X-ray spectrometry (SEM-EDX).

The shape of a Cu segregate near the interface between the base and the glass portion can be determined by measuring the concentration distribution of the Cu element from an elemental mapping image in the vicinity of the interface between the base and the glass portion obtained by SEM-EDX.

In a base made of ferrite, the base contains an Fe element as a main component, the Cu segregate contains a Cu element as a main component, and the glass portion of the underlying electrode layer contains a Si element as a main component. Thus, the base, the Cu segregate, and the glass portion in an elemental mapping image can be distinguished by comparing the concentrations of the Fe element, the Cu element, and the Si element in the elemental mapping image.

In a base made of a ceramic other than ferrite, the base, the Cu segregate, and the glass portion in an elemental mapping image can be distinguished by comparing the concentrations of the element of the main component of the ceramic, the Cu element, and the Si element. For example, the element of the main component of the ceramic may be an Al element in a base made of alumina, a Ti element or a Ba element in a base made of barium titanate for a capacitor, or a Zn element in a base made of a Zn ceramic for a thermistor.

When copper plating is used for the covering layer of the outer electrode, the Cu segregate and the copper plating layer can be distinguished by measuring the concentration distribution of an O element.

In the copper plating layer composed mostly of pure copper, the O element is rarely detected. In contrast, an O element derived from CuO or Cu₂O is detected in the Cu segregate.

As described above, even when copper plating is used for the covering layer, the Cu segregate and the copper plating layer can be distinguished from each other. The copper plating layer and the Cu segregate in the same field of view, however, reduce sensitivity in the concentration distribution of the Cu element in the Cu segregate. When the Cu segregate is observed by SEM-EDX, therefore, it is preferable that the copper plating layer is not present in the same field of view.

The Cu segregate may have any shape and may be granular, wedge-shaped, or layered.

The shape of the Cu segregate can be determined by the value of the aspect ratio and by whether or not the Cu segregate protrudes toward the base.

The aspect ratio of the Cu segregate is represented by the ratio [La/Lb] of a length La to a length Lb (hereinafter also referred to as an aspect ratio), wherein La denotes the length of the Cu segregate in the direction in which the interface between the base and the glass portion extends, and Lb denotes the length of the Cu segregate in a direction perpendicular to the direction of La. The length Lb corresponds to the distance between two imaginary lines that pass through the points on the Cu segregate closest to the base and farthest from the base and that are parallel to the direction in which the interface between the base and the glass portion extends.

A Cu segregate with a shape protruding toward the base has a wedge shape regardless of the aspect ratio of the Cu segregate.

When the Cu segregate does not have a wedge shape, the shape with an aspect ratio of 3 or less is a granular shape, and the shape with an aspect ratio of more than 3 is a layer shape.

In the Cu segregate with a wedge shape, the Cu segregate excluding the portion protruding toward the base may have a granular shape or a layer shape.

A layered Cu segregate is present only in a portion of the interface between the base and the glass portion and does not cover the entire interface between the base and the glass portion.

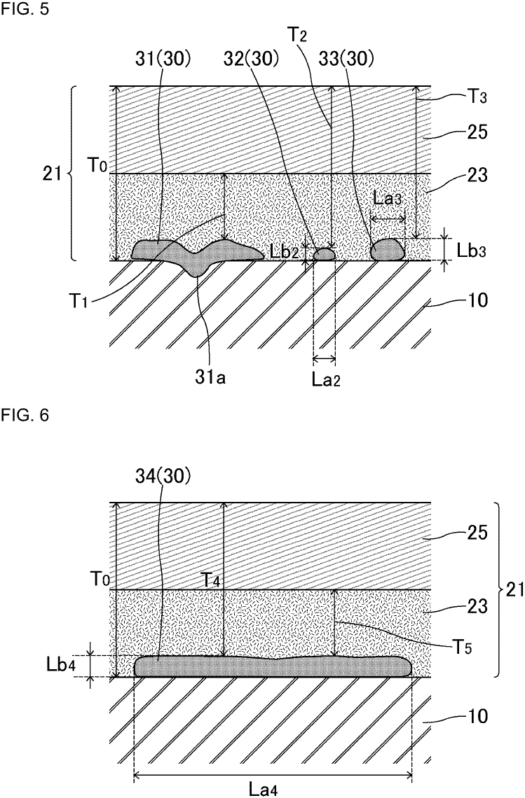

FIG. 5 is a schematic cross-sectional view of one example of the state of an interface between a base and a glass portion in one embodiment of an electronic component according to the present disclosure.

As illustrated in FIG. 5, the underlying electrode layer 21 includes a glass portion 23 containing glass and a conductor portion 25 containing a conductor. Although the glass portion 23 in FIG. 5 is relatively large for convenience of description, the relationship in size between the glass portion 23 and the conductor portion 25 is not limited to that of the structure in the drawing. FIG. 5 illustrates a portion of the underlying electrode layer 21, and a portion of the conductor portion 25 is in contact with the base 10. Thus, the underlying electrode layer 21 is electrically conductive as a whole.

A Cu segregate 30 (31, 32, 33) is present at the interface between the base 10 and the glass portion 23 and is in contact with the base 10 and the glass portion 23. A portion without the Cu segregate 30 in the underlying electrode layer 21 (the underlying electrode layer 21 immediately above the base 10) has a thickness corresponding to the length indicated by the double-headed arrow T₀. The thickness T₀ of the underlying electrode layer 21 may vary from place to place.

In FIG. 5, it can be said that a plurality of Cu segregates are present at the interface between the glass portion 23 and the base 10.

The Cu segregate 31 has a protrusion 31a protruding toward the base 10. It can therefore be said that the Cu segregate 31 has a wedge shape regardless of the aspect ratio.

Whether or not a Cu segregate protrudes toward the base is determined by estimating the shape of the base surface without the Cu segregate in a portion with the Cu segregate from the shape of the base surface in a portion without the Cu segregate on the surface of the base. The presence of a Cu segregate inside the estimated base surface (on the base side) is considered that the Cu segregate protrudes toward the base.

A Cu segregate may protrude not toward the base but toward the glass portion (toward the underlying electrode layer). The shape of a Cu segregate protruding not toward the base but only toward the glass portion is determined to be granular or layered from the aspect ratio.

The length of the Cu segregate 32 in the direction in which the interface between the base 10 and the glass portion 23 extends (hereinafter also referred to as a transverse direction) is the length indicated by the double-headed arrow La₂. The length of the Cu segregate 32 in the direction perpendicular to the transverse direction (hereinafter also referred to as a longitudinal direction) is the length indicated by the double-headed arrow Lb₂. The Cu segregate 32 has an aspect ratio [La₂/Lb_{2]} of approximately 1.4. Thus, the Cu segregate 32 has a granular shape.

The thickness of the Cu segregate 32 is the length indicated by the double-headed arrow Lb₂, and the thickness of the underlying electrode layer 21 immediately above the Cu segregate 32 is the length indicated by the double-headed arrow T₂.

The Cu segregate 32 has a shape that does not protrude toward the base 10. In FIG. 5, the sum of the thickness Lb₂ of the Cu segregate 32 and the thickness T₂ of the underlying electrode layer 21 immediately above the Cu segregate 32 is equal to the thickness T₀ of the underlying electrode layer 21.

The thickness T₀ of the underlying electrode layer 21 is larger than the thickness T₂ of the underlying electrode layer 21 immediately above the Cu segregate 32. The thickness T₀ of the underlying electrode layer 21 larger than the thickness T₂ of the underlying electrode layer 21 immediately above the Cu segregate 32 results in the underlying electrode layer with reduced surface unevenness caused by the presence of the Cu segregate and the underlying electrode layer with improved surface smoothness.

The Cu segregate 33 has a length La₃ in the transverse direction and a length Lb₃ in the longitudinal direction and has an aspect ratio [La₃/Lb₃] of approximately 1.9. Thus, the Cu segregate 33 has a granular shape.

The thickness of the Cu segregate 33 is the length indicated by the double-headed arrow Lb₃, and the thickness of the underlying electrode layer 21 immediately above the Cu segregate 33 is the length indicated by the double-headed arrow T₃.

The Cu segregate 33 has a shape that does not protrude toward the base 10. In FIG. 5, the sum of the thickness Lb₃ of the Cu segregate 33 and the thickness T₃ of the underlying electrode layer 21 immediately above the Cu segregate 33 is equal to the thickness T₀ of the underlying electrode layer 21.

The thickness T₀ of the underlying electrode layer 21 is larger than the thickness T₃ of the underlying electrode layer 21 immediately above the Cu segregate 33.

FIG. 6 is a schematic cross-sectional view of another example of the state of an interface between a base and a glass portion in one embodiment of an electronic component according to the present disclosure.

A Cu segregate 34 has a length indicated by the double-headed arrow La₄ in the transverse direction and a length indicated by the double-headed arrow Lb₄ in the longitudinal direction. The aspect ratio [La₄/Lb₄] is approximately 10. Thus, the Cu segregate 34 has a layer shape.

The layered Cu segregate does not spread over the entire interface between the base and the glass portion but spreads over only a portion of the interface between the base and the glass portion.

The thickness of the Cu segregate 34 is the length indicated by the double-headed arrow Lb₄, and the thickness of the underlying electrode layer 21 immediately above the Cu segregate 34 is the length indicated by the double-headed arrow T₄.

The Cu segregate 34 has a shape that does not protrude toward the base 10. In FIG. 6, the sum of the thickness Lb₄ of the Cu segregate 34 and the thickness T₄ of the underlying electrode layer 21 immediately above the Cu segregate 34 is equal to the thickness T₀ of the underlying electrode layer 21.

The thickness T₀ of the underlying electrode layer 21 is larger than the thickness T₄ of the underlying electrode layer 21 immediately above the Cu segregate 34.

The shape of a Cu segregate is related to the thickness of the glass portion immediately above the Cu segregate.

When the glass portion immediately above a Cu segregate has a thickness of less than 0.5 µm, the Cu segregate tends to have a granular or wedge shape.

On the other hand, when the glass portion immediately above a Cu segregate has a thickness of 0.5 µm or more, the Cu segregate tends to have a layer shape.

In determining the shape of a Cu segregate, a portion where the Cu segregate is mixed with the glass portion is also regarded as a portion of the Cu segregate. Thus, the shape is determined as one Cu segregate including the portion where the Cu segregate is mixed with the glass portion. The boundary between the glass portion and the portion where the Cu segregate is mixed with the glass portion can be identified by elemental mapping of a Si element and a Cu element using SEM-EDX.

The shape and aspect ratio of a Cu segregate and the thickness of the glass portion immediately above the Cu segregate can be measured by SEM-EDX.

The shape and aspect ratio of a Cu segregate are determined for each Cu segregate.

The thickness of the glass portion immediately above a Cu segregate is defined, from a SEM-EDX image taken such that the Cu segregate and the glass portion are included in one field of view, as the minimum value of the length of each Cu segregate from a point on the upper surface of the Cu segregate to a point on the top surface of the glass portion immediately above the Cu segregate in the longitudinal direction.

For example, the thickness of the glass portion 23 immediately above the Cu segregate 31 illustrated in FIG. 5 is the length indicated by the double-headed arrow T₁. The thickness of the glass portion 23 immediately above the Cu segregate 34 illustrated in FIG. 6 is the length indicated by the double-headed arrow T₅.

The thickness of the underlying electrode layer immediately above a Cu segregate is defined, from a SEM-EDX image taken such that the Cu segregate and the underlying electrode layer are included in one field of view, as the minimum value of the length of each Cu segregate from a point on the upper surface of the Cu segregate to a point on the top surface of the underlying electrode layer immediately above the Cu segregate in the longitudinal direction.

The thickness of the underlying electrode layer in a portion with no Cu segregate is the average value of the lengths from the surface of the base to the top surface of the underlying electrode layer measured at three positions. The selected three positions are points with the maximum length, the minimum length, and the intermediate length from the surface of the base to the top surface of the underlying electrode layer in visual observation.

Although the examples in which the glass portion is located immediately above a Cu segregate have been described, there may be a Cu segregate immediately above which the conductor portion instead of the glass portion is located.

Thus, there may be a Cu segregate not covered with the glass portion included in the underlying electrode layer.

When a plurality of Cu segregates are present, it is sufficient if at least one Cu segregate is present at the interface between the base and the glass portion, and the other Cu segregates may be present at the interface between the base and the conductor portion or at the interface between the base and the covering layer. Thus, a plurality of Cu segregates may be present at the interface between the base and the underlying electrode layer.

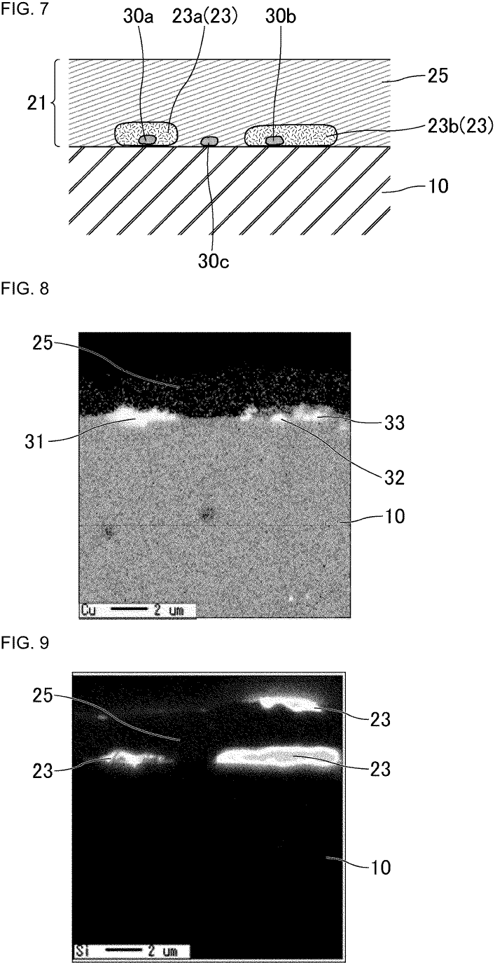

FIG. 7 is a schematic cross-sectional view of still another example of the state of an interface between a base and a glass portion in one embodiment of an electronic component according to the present disclosure.

The underlying electrode layer 21 is provided on the surface of the base 10 in FIG. 7. The underlying electrode layer 21 has a plurality of glass portions 23 (23a, 23b) and the conductor portion 25.

Cu segregates 30a and 30b are present at the interfaces between the base 10 and the glass portions 23a and 23b, respectively.

There is a portion not covered with the glass portions 23 on the surface of the base 10, and this portion is covered with the conductor portion 25. A Cu segregate 30c is present not in the glass portions 23 but in a portion covered with the conductor portion 25. Thus, the conductor portion 25 is present immediately above the Cu segregate 30c.

In FIG. 7, it can also be said that a plurality of glass portions are present in one underlying electrode layer, a Cu segregate is present at the interface between one of the plurality of glass portions and the base, and a Cu segregate containing a Cu element is present at the interface between at least one of the remaining glass portions and the base.

One embodiment of an electronic component according to the present disclosure may have an insulating film containing glass partially covering the surface of the base.

The glass constituting the underlying electrode layer can be suitably used as the glass constituting the insulating film. However, the glass constituting the insulating film may be the same as or different from the glass constituting the underlying electrode layer.

A Cu segregate may be present at the interface between the base and the insulating film.

A Cu segregate may also be present on a portion of the surface of the base not covered with the underlying electrode layer.

The electronic component according to the present embodiment has high adhesion between the base and the outer electrode. The electronic component according to the present embodiment is not limited to a multilayer coil component or a wound coil component and may be any component including, as the base, a ceramic containing a Cu element.

### Method for Producing Electronic Component

### (First Embodiment)

A first embodiment of a method for producing an electronic component according to the present disclosure includes a ceramic sheet preparation step of preparing a ceramic sheet by shaping a ceramic raw material containing a Cu element into a sheet, a conductor pattern formation step of forming a conductor pattern to be a via-hole and a coil pattern on the ceramic sheet, a multilayer body preparation step of preparing a multilayer body by stacking the ceramic sheets, a firing step of firing the multilayer body to prepare a ceramic base, and an underlying electrode layer formation step of forming an underlying electrode layer that has a conductor portion containing a conductor and a glass portion containing glass on the surface of the base.

### Ceramic Sheet Preparation Step

In the ceramic sheet preparation step, a ceramic raw material containing a Cu element is shaped into a sheet.

When a ferrite raw material is used as the ceramic raw material, a powdered ferrite raw material can be prepared, for example, by weighing and wet-blending Fe₂O₃, ZnO, CuO, and NiO at a predetermined ratio, and then pulverizing, drying, and calcining the mixture.

Subsequently, a ceramic raw material, an organic binder, such as a poly(vinyl butyral) resin, an organic solvent, such as ethanol or toluene, and the like are mixed and then pulverized to prepare a ceramic slurry. Next, the ceramic slurry is shaped into a sheet with a predetermined thickness by a doctor blade method or the like and is then punched out into a predetermined shape to prepare a ceramic sheet.

The ceramic raw material preferably has a Cu element content of 6% by mole or more and 10% by mole or less (i.e., from 6% by mole to 10% by mole). At a higher Cu element content of the ceramic raw material, a Cu segregate is more likely to be formed on the surface of the base.

The ceramic sheet preferably has an organic binder content of 25% by weight or more and 35% by weight or less (i.e., from 25% by weight to 35% by weight).

The organic binder in the ceramic sheet contains carbon, which combines with oxygen in the atmosphere during firing and decreases the oxygen concentration. Thus, a higher organic binder content tends to result in a lower oxygen concentration in the firing step and consequently a higher occurrence of a Cu segregate on the surface of the base.

The thickness of the ceramic sheet is preferably, but not limited to, 15 µm or more and 50 µm or less (i.e., from 15 µm to 50 µm).

### Conductor Pattern Formation Step

In the conductor pattern formation step, an electrically conductive paste, such as an Ag paste, is applied to each ceramic sheet by a screen printing method or the like to form a conductor pattern. To form a conductor pattern to be a via-conductor, a via-hole is formed in advance by irradiating a predetermined portion of a ceramic sheet with a laser and is filled with an electrically conductive paste.

### Multilayer Body Preparation Step

The ceramic sheets are stacked and are then pressure-bonded by warm isostatic pressing (WIP) or the like to prepare a multilayer body.

The number of ceramic sheets to be stacked is preferably, but not limited to, 30 or more and 100 or less (i.e., from 30 to 100).

### [Firing Step]

In the firing step, the multilayer body is fired to prepare a base.

The firing conditions are such that a Cu segregate derived from Cu in the base precipitates on the surface of the base.

Whether or not a Cu segregate is formed on the surface of the base depends not only on the composition of the ceramic raw material but also on the amount of carbon in the multilayer body, the firing temperature (maximum temperature), the heating rate, the firing atmosphere, the material of a firing furnace, and the like. When these conditions are appropriately selected, a Cu segregate precipitates on the surface of the base.

Thus, under inappropriate firing conditions, even using the ceramic raw material with the same composition, a Cu segregate does not precipitate on the surface of the base.

The firing temperature (maximum temperature) in the firing step is preferably 1000° C. or more and 1300° C. or less (i.e., from 1000° C. to 1300° C.).

At a firing temperature (maximum temperature) of 1000° C. or more in the firing step, a Cu segregate tends to be formed on the surface of the base.

The oxygen concentration in the firing step is preferably 15% by volume or less, more preferably 5% by volume or less. At an oxygen content of 15% by volume or less in the firing atmosphere, a Cu segregate tends to be formed on the surface of the base.

The balance gas in the firing step is preferably nitrogen or argon.

The heating rate in the firing step is preferably 10° C./min or less.

A shorter time to reach the firing temperature results in a higher occurrence of a Cu segregate on the surface of the base.

A furnace material constituting a firing furnace for firing the multilayer body in the firing step is preferably a high-density material, such as a mixture of alumina and silicon.

When a furnace material constituting a firing furnace is composed of a high-density material, a Cu segregate tends to be formed.

### Underlying Electrode Layer Formation Step

In the underlying electrode layer formation step, an underlying electrode layer that has a conductor portion containing a conductor and a glass portion containing glass is formed on the surface of the base prepared in the firing step.

The underlying electrode layer can be formed by applying a paste containing electrically conductive particles and glass (hereinafter referred to as a glass paste) to the surface of the base and firing (baking) the paste.

The glass paste may contain a resin and a dispersion medium in addition to the electrically conductive particles and glass.

Examples of the electrically conductive particles include electrically conductive particles containing at least one metal element selected from the group consisting of a Ni element, a Sn element, a Pd element, a Au element, a Ag element, a Pt element, a Bi element, a Zn element, and a Cu element.

The average particle size of the electrically conductive particles is preferably, but not limited to, 0.5 µm or more and 10 µm or less (i.e., from 0.5 µm to 10 µm).

A larger average particle size of the electrically conductive particles constituting the glass paste tends to result in the glass paste with a larger number of voids before sintering and the underlying electrode layer with a smaller thickness due to baking. Thus, a granular or wedge-shaped Cu segregate tends to be formed.

On the other hand, a smaller average particle size of the electrically conductive particles constituting the glass paste tends to result in the glass paste with a smaller number of voids before sintering and the underlying electrode layer with a larger thickness due to baking. Thus, a layered Cu segregate tends to be formed.

Examples of the glass include B-Si glass, Ba-B-Si glass, B-Si-Zn glass, B-Si-Zn-Ba glass, and B-Si-Zn-Ba-Ca-Al glass. In addition to these, alkali metal glasses, such as Na-Si glass, K-Si glass, and Li-Si glass; alkaline-earth metal glasses, such as Mg-Si glass, Ca-Si glass, Ba-Si glass, and Sr-Si glass; and Ti-Si glass, Zr-Si glass, and Al-Si glass can also be used.

The glass may be crystalline glass.

The average particle size of the glass constituting the glass paste is preferably, but not limited to, 0.5 µm or more and 10 µm or less (i.e., from 0.5 µm to 10 µm).

A larger average particle size of the glass constituting the glass paste tends to result in the glass paste with lower fluidity during baking and the underlying electrode layer with a larger thickness. Thus, a layered Cu segregate tends to be formed.

On the other hand, a smaller average particle size of the glass constituting the glass paste tends to result in the glass paste with higher fluidity during baking and the underlying electrode layer with a smaller thickness. Thus, a granular or wedge-shaped Cu segregate tends to be formed.

The temperature at which the glass paste is fired (baking temperature) is preferably, but not limited to, 750° C. or more and 900° C. or less (i.e., from 750° C. to 900° C.).

A baking temperature of 750° C. or more and 900° C. or less (i.e., from 750° C. to 900° C.) tends to result in a higher occurrence of a Cu segregate on the surface of the base. Furthermore, a Cu segregate and glass contained in the glass portion of the underlying electrode layer can easily form a mixture, which can improve the adhesion between the base and the underlying electrode layer.

The baking is preferably performed in a nonoxidizing atmosphere.

Baking in a nonoxidizing atmosphere at 825° C. or more can promote the segregation of Cu on the surface of the base. This can further improve the adhesion between the base and the underlying electrode layer.

The resin in the glass paste may be a poly(vinyl butyral) resin.

The resin content of the glass paste is preferably 20% by weight or more and 30% by weight or less (i.e., from 20% by weight to 30% by weight).

The resin content of the glass paste in such a range can result in promoted segregation of Cu on the surface of the base.

A covering layer is preferably formed on the surface of the underlying electrode layer.

The covering layer is preferably a plating layer formed by plating treatment.

The plating layer preferably contains at least one metal selected from the group consisting of Cu, Ni, Sn, Pd, Au, Ag, Pt, Bi, and Zn. The plating layer may be a single layer or two or more layers. The plating layer is more preferably a layer including a nickel plating layer and a tin plating layer provided on the underlying electrode layer.

After the plating layer is formed, heating may be further performed.

The method for producing the base may be a method other than the sheet lamination method described above.

The method other than the sheet lamination method is, for example, a printing lamination method (build-up method). In addition to the method described above, a method using photolithography can also be used as a method for forming wiring or a via on a sheet surface.

An electronic component with a conductor layer inside a base, for example, as illustrated in FIGS. 1 and 2 can be produced by the steps described above.

### Second Embodiment

A second embodiment of a method for producing an electronic component according to the present disclosure includes a base preparation step of shaping a ceramic raw material containing a Cu element to prepare a ceramic base containing a Cu element, an underlying electrode layer formation step having a conductor portion containing a conductor and a glass portion containing glass on the surface of the base, and a coil formation step of winding a winding wire to be a coil around the surface of the base.

### Base Preparation Step

The ceramic raw material used in the first embodiment of a method for producing an electronic component according to the present disclosure can be suitably used as a ceramic raw material used in the base preparation step.

A known powder shaping method can be used as a method for shaping a ceramic raw material into a predetermined shape. A resin, a binder, or the like may be added to the ceramic raw material as required. A green body prepared by shaping a ceramic raw material is fired to prepare a base. The green body is fired under the conditions that a Cu segregate is formed on the surface of the base.

The base prepared by this method is a base with no conductor layer inside.

### Underlying Electrode Layer Formation Step

The underlying electrode layer formation step in the second embodiment of a method for producing an electronic component according to the present disclosure is the same as the underlying electrode layer formation step in the first embodiment of a method for producing an electronic component according to the present disclosure.

### Coil Formation Step

In the coil formation step, a winding wire to be a coil is wound around the surface of the base, and each end of the coil is coupled to an outer electrode. The winding wire to be a coil may be coupled to an outer electrode by any method, for example, by a bonding method utilizing thermocompression bonding.

The number of windings (turns) of the winding wire and the diameter of the winding wire may be appropriately changed in accordance with the specification required for the electronic component.

An electronic component with a winding wire to be a coil wound around a base, for example, as illustrated in FIGS. 3 and 4 can be produced by these steps.

### EXAMPLES

One embodiment of an electronic component according to the present disclosure is more specifically disclosed in the following examples. The present disclosure is not limited to these examples.

### Example 1

### [Base Preparation Step]

A ferrite raw material prepared so as to have a constant Fe content, a Ni/Zn mole ratio of 2.3, and a Cu content of 8% by mole was shaped in a barbell shape having a winding wire portion and a flange to prepare a green body.

The green body was fired at 1100° C. for 1 hour to prepare a ceramic base. The atmosphere during firing was at atmospheric pressure and at an oxygen partial pressure of 10% by volume.

### [Outer Electrode Formation Step]

A glass paste was prepared by mixing a mixture of a glass frit (borosilicate glass) and Ag particles mixed at 5:95 (weight ratio) and a solvent, was applied to the surface of the base prepared in the firing step, and was baked at 650° C. for 40 minutes to form an underlying electrode layer. Plating treatment was performed on the surface of the underlying electrode layer to form a nickel plating layer as a covering layer and thereby produced an electronic component according to Example 1. The segregation amount of Cu segregate is more easily increased at a higher baking temperature. Thus, the baking temperature is preferably 750° C. or more, and the fluidity of a Cu segregate is improved at a baking temperature of 850° C. or more.

### Example 2, Comparative Examples 1 to 3

Electronic components according to Example 2 and Comparative Examples 1 to 3 were produced in the same manner as in Example 1 except that the Cu content was changed to 6% by mole, 4% by mole, 1% by mole, and 0% by mole without changing the Fe content and the Ni/Zn mole ratio of the ferrite raw material. The base of each of the example and the comparative examples had approximately the same sintered density as Example 1.

### (Comparative Example 4)

An electronic component according to Comparative Example 4 was produced in the same manner as in Example 1 except that the firing temperature (maximum temperature) of the green body was changed to 950° C. or less without changing the composition of the ferrite raw material. The base of Comparative Example 4 had approximately the same sintered density as Example 1.

### [Measurement of Cu Content of Base]

The Cu content of the base measured by WD-XRF described above was the same as the Cu content of the ferrite raw material in all the examples and comparative examples.

### Observation by SEM-EDX

In the electronic component according to Example 2, two portions near the interface between the base and the glass portion were observed by SEM-EDX for elemental mapping of Cu and elemental mapping of Si. FIGS. 8, 9, 11, and 12 show the results.

In the electronic components according to Example 1 and Comparative Examples 1 to 4, the vicinity of the interface between the base and the glass portion was observed by SEM-EDX. In the electronic component according to Example 1, a Cu segregate in contact with the base and the glass was observed at the interface between the base and the glass portion. In contrast, in the electronic components according to Comparative Examples 1 to 4, no Cu segregate was observed.

FIG. 8 is an elemental mapping image of Cu at the interface between the base and the glass portion of the electronic component according to Example 2. FIG. 9 is an elemental mapping image of Si in the same field of view as in FIG. 8. FIG. 10 is a superimposed image of FIG. 8 and FIG. 9.

The results of FIGS. 8, 9, and 10 showed that the electronic component according to Example 2 had a region with a high Cu concentration (Cu segregates 31, 32, and 33) at the interface between the base 10 and the glass portion 23. It could be confirmed that a wedge-shaped Cu segregate 31 was present on the left side of FIGS. 8, 9 and 10, and a plurality of granular Cu segregates (Cu segregates 32 and 33) were present on the right side of FIGS. 8, 9 and 10. The thickness of the glass portion 23 immediately above the wedge-shaped Cu segregate 31 in FIGS. 8, 9, and 10 was 0.4 µm. The aspect ratios of the granular Cu segregates 32 and 33 in FIGS. 8, 9 and 10 ranged from approximately 1.2 to 1.9, all of which were smaller than 3. The thickness of the glass portion 23 immediately above the granular Cu segregate 32 was 0.3 µm.

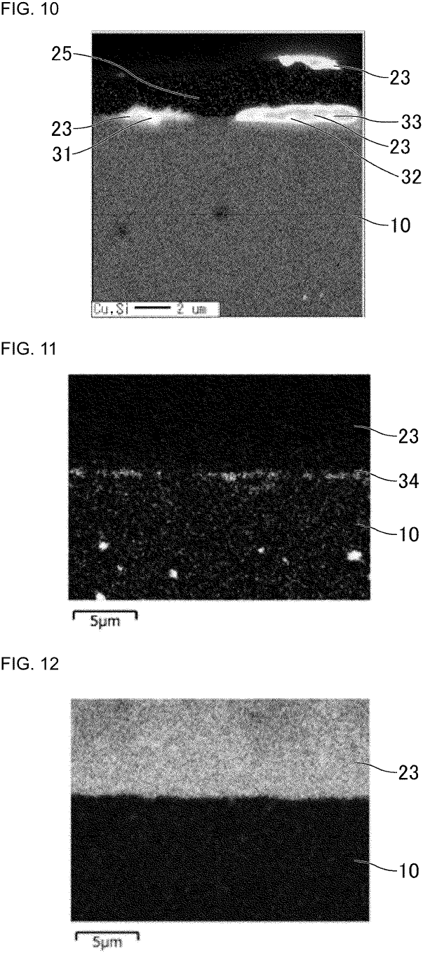

FIG. 11 is an elemental mapping image of Cu at the interface between the base and the glass portion of the electronic component according to Example 2. FIG. 12 is an elemental mapping image of Si in the same field of view as in FIG. 11. The SEM-EDX measurement positions in FIGS. 11 and 12 are different from the SEM-EDX measurement positions in FIGS. 8 and 9.

The results of FIG. 11 showed that the electronic component according to Example 2 had a region with a high Cu concentration (Cu segregate 34) at the interface between the base 10 and the glass portion 23.

In FIG. 11, white dots indicating a high Cu concentration represented portions that were not continuous along the interface between the base 10 and the underlying electrode layer 21. The Si elemental mapping of SEM-EDX shown in FIG. 12 showed that the Si concentration in these portions is lower than the Si concentration in the underlying electrode layer 21, and it is thought that Cu segregates in these portions contain the glass constituting the underlying electrode layer 21. Thus, it can be said that the Cu segregates 34 at the interface between the base 10 and the underlying electrode layer 21 in FIGS. 11 and 12 are continuously disposed along the interface between the base 10 and the underlying electrode layer 21 and have a layer shape as a whole. The aspect ratio of the layered Cu segregates 34 was more than 3, and the thickness of the glass portion 23 immediately above the Cu segregates 34 was 5 µm or more.

The results of FIGS. 8, 9, 10, 11, and 12 showed that a plurality of Cu segregates with different shapes were present at the interface between the glass portion and the base in the electronic component.

### Evaluation of Separation

The adhesion between a base and an underlying electrode layer was evaluated by the following method. Table 1 shows the results.

The interface between the base and the underlying electrode layer was exposed by polishing the electronic component and was observed by SEM-EDX to check the base and the underlying electrode layer for separation. The same operation was performed on five samples in total, and the incidence of separation was evaluated as separation [%].

TABLE 1

| | Example 1 | Example 2 | Comparative example 1 | Comparative example 2 | Comparative example 3 | Comparative example 4 |
|---|---|---|---|---|---|---|
| Cu content of base [mol%] | 8 | 6 | 4 | 1 | 0 | 8 |
| Separation [%] | 0 | 0 | 40 | 80 | 100 | 20 |

The results in Table 1 showed that an electronic component according to the present disclosure had high adhesion between the base and the underlying electrode layer.

### Industrial Applicability

An electronic component according to an embodiment of the present disclosure can be suitably used as a component, such as an inductor, an antenna, a noise filter, an electromagnetic wave absorber, an LC filter combined with a capacitor, or the like.

What is claimed is:

1. An electronic component comprising:
a ceramic base including a Cu element;
an outer electrode partially covering a surface of the base; and
a Cu segregate includes a Cu element,
wherein the outer electrode has an underlying electrode layer on the base,
the underlying electrode layer has a conductor portion including a conductor and a glass portion including glass, and
the Cu segregate is in contact with the base and the glass portion at an interface between the base and the glass portion.

2. The electronic component according to claim 1, wherein
the Cu segregate partially protrudes toward the base and has a wedge shape.

3. The electronic component according to claim 1, wherein
the Cu segregate has a granular shape with a ratio [La/Lb] of a length La to a length Lb of 3 or less, wherein La denotes a length of the Cu segregate in a direction in which the interface between the base and the glass portion extends, and Lb denotes a length of the Cu segregate in a direction perpendicular to the direction of La.

4. The electronic component according to claim 2, wherein
the glass portion immediately above the Cu segregate has a thickness of less than 0.5 µm.

5. The electronic component according to claim 1, wherein
the Cu segregate is a layer with a ratio [La/Lb] of a length La to a length Lb of more than 3, wherein La denotes a length of the Cu segregate in a direction in which the interface between the base and the glass portion extends, and Lb denotes a length of the Cu segregate in a direction perpendicular to the direction of La.

6. The electronic component according to claim 5, wherein
the glass portion immediately above the Cu segregate has a thickness of 0.5 µm or more.

7. The electronic component according to claim 1, wherein
a plurality of the Cu segregates are at the interface between the base and the underlying electrode layer.

8. The electronic component according to claim 7, wherein
the underlying electrode layer includes a plurality of the glass portions,
the Cu segregate is at an interface between one of the plurality of the glass portions and the base, and
a Cu segregate including a Cu element is at an interface between at least one of the remaining glass portions and the base.

9. The electronic component according to claim 7, wherein
a plurality of the Cu segregates are at the interface between the glass portion and the base.

10. The electronic component according to claim 1, wherein
the conductor portion configuring the underlying electrode layer includes a Ag element as a conductor.

11. The electronic component according to claim 3, wherein
the glass portion immediately above the Cu segregate has a thickness of less than 0.5 µm.

12. The electronic component according to claim 2, wherein
a plurality of the Cu segregates are at the interface between the base and the underlying electrode layer.

13. The electronic component according to claim 3, wherein
a plurality of the Cu segregates are at the interface between the base and the underlying electrode layer.

14. The electronic component according to claim 4, wherein
a plurality of the Cu segregates are at the interface between the base and the underlying electrode layer.

15. The electronic component according to claim 5, wherein
a plurality of the Cu segregates are at the interface between the base and the underlying electrode layer.

16. The electronic component according to claim 6, wherein
a plurality of the Cu segregates are at the interface between the base and the underlying electrode layer.

17. The electronic component according to claim 2, wherein
the conductor portion configuring the underlying electrode layer includes a Ag element as a conductor.

18. The electronic component according to claim 3, wherein
the conductor portion configuring the underlying electrode layer includes a Ag element as a conductor.

19. The electronic component according to claim 4, wherein
the conductor portion configuring the underlying electrode layer includes a Ag element as a conductor.

20. The electronic component according to claim 5, wherein
the conductor portion configuring the underlying electrode layer includes a Ag element as a conductor.
